(19) United States
(12) Patent Application Publication
(10) Pub. No.: US 2025/0151130 A1
(43) Pub. Date: May 8, 2025

(54) METHOD AND APPARATUS FOR MANAGING PDU SESSIONS IN WIRELESS COMMUNICATION SYSTEM

(71) Applicant: SAMSUNG ELECTRONICS CO., LTD., Suwon-si, Gyeonggi-do (KR)

(72) Inventors: Mahmoud WATFA, Staines, Middlesex (GB); Ashok Kumar NAYAK, Bangalore (IN); Danish Ehsan HASHMI, Bangalore (IN); Lalith KUMAR, Bangalore (IN)

(21) Appl. No.: 18/935,335

(22) Filed: Nov. 1, 2024

(30) Foreign Application Priority Data
Nov. 3, 2023 (IN) 202331075115
Oct. 22, 2024 (GB) 2415558.2

(51) Int. Cl. H04W 76/10; H04W 48/18; H04W 64/00

(52) U.S. Cl. CPC H04W 76/10; H04W 48/18; H04W 64/00

(57) ABSTRACT

The disclosure relates to a 5G or 6G communication system for supporting a higher data transmission rate. A method performed by an access and mobility management function (AMF) in wireless communication system, the method comprising: receiving, from a user equipment (UE), an uplink non-access stratum (UL NAS) transport message including a payload container type information element (IE) set to N1 SM information and a request type IE indicating initial request; and identifying that a single network slice selection assistance information (S-NSSAI) IE is not included in the UL NAS transport message.

### CROSS-REFERENCE TO RELATED APPLICATIONS

This application is based on and claims priority under 35 U.S.C. § 119 to Indian patent application Ser. No. 20/233,1075115 filed on Nov. 3, 2023, in the Indian Intellectual Property Office, and United Kingdom Patent Application No. 2415558.2 filed on Oct. 22, 2024, in the United Kingdom Intellectual Property Office the disclosures of which are incorporated by reference herein in their entirety.

### BACKGROUND

### 1. Field

The present invention relates to method and apparatus for managing PDU session in wireless communication system.

### 2. Description of Related Art

5G mobile communication technologies define broad frequency bands such that high transmission rates and new services are possible, and can be implemented not only in “Sub 6 GHZ” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure relates to improvements in and relating to managing PDU sessions.

According to an aspect of the present disclosure, there is provided a method performed by an access and mobility management function (AMF) in wireless communication system, the method comprising: receiving, from a user equipment (UE), an uplink non-access stratum (UL NAS) transport message including a payload container type information element (IE) set to N1 SM information and a request type IE indicating initial request; and identifying that a single network slice selection assistance information (S-NSSAI) IE is not included in the UL NAS transport message.

According to an aspect of the present disclosure, there is provided a method performed by a user equipment (UE) in wireless communication system, the method comprising: transmitting, to an access and mobility management function (AMF), an uplink non-access stratum (UL NAS) transport message including a payload container type information element (IE) set to N1 SM information and a request type IE indicating initial request, wherein a single network slice selection assistance information (S-NSSAI) IE is not included in the UL NAS transport message.

According to an aspect of the present disclosure, there is provided an access and mobility management function (AMF) in wireless communication system. The AMF comprises a transceiver; and a processor configured to: receive, from a user equipment (UE), an uplink non-access stratum (UL NAS) transport message including a payload container type information element (IE) set to N1 SM information and a request type IE indicating initial request, and identify that a single network slice selection assistance information (S-NSSAI) IE is not included in the UL NAS transport message.

According to an aspect of the present disclosure, there is provided a user equipment (UE) in wireless communication system. The UE comprises a transceiver; and a processor configured to: transmit, to an access and mobility management function (AMF), an uplink non-access stratum (UL NAS) transport message including a payload container type information element (IE) set to N1 SM information and a request type IE indicating initial request, wherein a single network slice selection assistance information (S-NSSAI) IE is not included in the UL NAS transport message.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawing, in which like reference numerals represent like parts:

FIG. 1 illustrates a schematic of a method of a UE according to an embodiment of the present disclosure.

FIG. 2 illustrates an example of an internal structure of an apparatus according to an embodiment of the disclosure.

### DETAILED DESCRIPTION

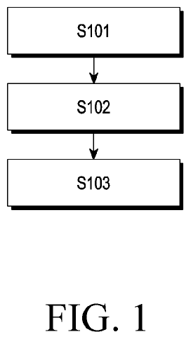

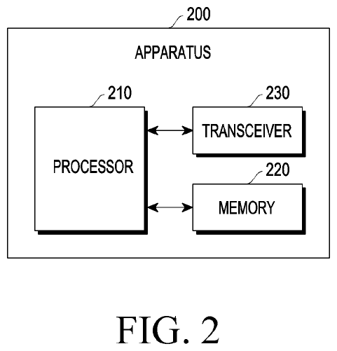

FIGS. 1-2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The present invention relates to the management of Protocol Data Unit, PDU, Sessions in a telecommunication network in the context of network slicing. A network slice, identified by Single Network Slice Selection Assistance Information, S-NSSAI, is a means by which a network is able to partition network capabilities and provide certain services within one or more specified slices.

A slice may not be available at all times and as such a User Equipment, UE, may only be able to make use of the services associated with that slice (e.g. by establishing a PDU session for that slice) during the period of availability as described in 3GPP TS 23.501 V18.2.1:

“5.15.16 Optimized handling of temporarily available network slices
A network slice may be available for all UEs or a limited number of UEs only for a limited time
that is known at the network in advance e.g. by OAM or subscription. The limited time duration
may be due to, for example, the fact that network slice is only temporarily or periodically active
in the deployment (e.g. for a limited time to serve an event or a UE may be only authorized to
access the network slice for a limited time known in advance), or the network slice is being
decommissioned at a known future time. This feature is enabled by S-NSSAI validity time that
the network and the UE can handle to reduce the signalling load associated to the transitions
in RM and SM states for the network slice.
The UE may indicate its support for temporarily available network slices in the UE MM Core
Network Capability (see clause 5.4.4a) in the Registration Request. The AMF, based on OAM
configuration or information received from the UDM or NSSF, may indicate to a supporting UE
the validity time for one or more S-NSSAIs in the Configured NSSAI in the Registration Accept
message or via the UE Configuration Update procedure. In roaming case, the AMF my include
the validity time for an S-NSSAI in the Configured NSSAI either because of limited availability
of the VPLMN S-NSSAI or the mapped S-NSSAI of the HPLMN.

| | |
|---|---|
| NOTE 1: | When the validity time changes or a validity time is determined for a S-NSSAI |

in the configured NSSAI, the PLMN provides the new validity time for the S-NSSAIs in the
Configured NSSAI to a supporting UE.
If a supporting UE is configured with validity time for an S-NSSAI:

| | |
|---|---|
| a) | If the validity time indicates the S-NSSAI is available, the UE may request the S-NSSAI |

in a Requested NSSAI in a Registration request and, if the S-NSSAI is included in the Allowed
NSSAI or in the Partially Allowed NSSAI, the UE may establish PDU sessions associated with
the S-NSSAI.

| | |
|---|---|
| b) | If the validity time indicates the S-NSSAI is not available |
| - | The UE shall not include the S-NSSAI in the Requested NSSAI; |
| - | If the S-NSSAI is already part of the Allowed NSSAI or Partially Allowed NSSAI, the |

UE shall remove the S-NSSAI from the locally stored Allowed NSSAI or Partially Allowed
NSSAI and the UE shall also locally release any PDU sessions associated with the S-NSSAI.

| | |
|---|---|
| - | If the validity time indicates the S-NSSAI will not be available again, the UE shall |

remove the S-NSSAI from the locally stored Configured NSSAI.

| | |
|---|---|
| NOTE 2: | Subject to implementation decisions outside 3GPP scope, the UE may also use |

the validity time information to e.g. attempt to use another PDU sessions to continue supporting
the connectivity with another connectivity option if possible according to the URSP rules, or, if
not possible, e.g. provide implementation-dependent information on the availability of
connectivity for specific applications affected by an impending connectivity loss, so the UE can
let the end user prepare for the loss of connectivity.
For a supporting UE, if validity time applies to an S-NSSAI, an AMF supporting temporarily
available network slices shall:

| | |
|---|---|
| - | If the S-NSSAI is provided in a Requested NSSAI in a Registration Request by the UE |

and the validity time indicates the S-NSSAI is not available, but it is going to become available
again (i.e. the UE is detected as not having up to date validity time), then the AMF sends the
Configured NSSAI to the UE including the validity time for the S-NSSAI in the Registration
Accept message. If the validity time indicates the S-NSSAI is not available and will not become
available again, then the AMF sends the Configured NSSAI to the UE, excluding the S-NSSAI
from the Configured NSSAI.

| | |
|---|---|
| - | If the S-NSSAI is in the Allowed NSSAI or the Partially Allowed NSSAI for the UE and |

the validity time indicates that the S-NSSAI is not available, then locally remove (i.e. without
sending any signalling to the UE) the S-NSSAI from the Allowed NSSAI or Partially Allowed
NSSAI. If there is any PDU session established for the S-NSSAI, the AMF requests the SMF to
release the PDU session:

| | |
|---|---|
| - | If the UE is in CM-CONNECTED state, the AMF releases the PDU session for the S- |

NSSAI by sending to the SMF, as per step If in clause 4.3.4.2 of TS 23.502 [3], a
Nsmf_PDUSession_UpdateSMContext Request with a release indication to request the release
of the PDU Session and then the AMF forwards the N2 SM request to release the AN resources
associated with the PDU session

| | |
|---|---|
| - | If the UE is in CM-IDLE state, the AMF locally releases the PDU session without |

paging the UE and causes the SMF to locally release the SM context for the UE by a
Nsmf_PDUSession_ReleaseSMContext, as in step 1c in clause 4.3.4.2 of TS 23.502 [3]. The
PDU Session status is synchronized at next time when the UE connects to the network.
For a non-supporting UE, if validity time applies to an S-NSSAI, an AMF supporting
temporarily available network slices shall:

| | |
|---|---|
| - | If the validity time indicates the S-NSSAI is available, allow or partially allow the |

network slice when requested, establish PDU sessions when requested.

| | |
|---|---|
| - | If the S-NSSAI is provided in a Requested NSSAI in a Registration Request by the UE |

and the validity time indicates the S-NSSAI is not available, reject the registration and remove
the S-NSSAI from the Configured NSSAI by providing an updated Configured NSSAI in the
Registration Accept message.

| | |
|---|---|
| - | If the S-NSSAI is in the UE in the Allowed NSSAI or Partially Allowed NSSAI and the |

validity time indicates the S-NSSAI is not available, remove the S-NSSAI from the Configured
NSSAI and the Allowed NSSAI or Partially Allowed NSSAI by a UE Configuration Update
procedure. If there is any PDU session established for the S-NSSAI, the AMF requests the SMF
to release the PDU session in the network:

| | |
|---|---|
| - | If the UE is in CM-CONNECTED state, the AMF releases the PDU session for the S- |

NSSAI by sending to the SMF, as in step If in clause 4.3.4.2 of TS 23.502 [3], a
Nsmf_PDUSession_UpdateSMContext Request with a release indication to request the release
of the PDU Session and then the AMF forwards the N2 SM request to release the AN resources
associated with the PDU session

| | |
|---|---|
| - | If the UE is in CM-IDLE, the AMF locally releases the PDU session without paging the |

UE and causes the SMF to locally release the SM context for the UE by a
Nsmf_PDUSession_ReleaseSMContext, as in step 1c in clause 4.3.4.2 of TS 23.502 [3]. The
PDU Session status is synchronized at next time when the UE connects to the network

| | |
|---|---|
| NOTE 3: | If the network slice becomes unavailable, and a large number of UEs are |

impacted, the AMF can send the updates to the non-supporting UEs in a manner that avoids
surge in signalling (e.g. next time the UE becomes connected).

| | |
|---|---|
| - | If the AMF detects from the validity time of a S-NSSAI that it is available again, then |

update the Configured NSSAI to include the S-NSSAI via a UE Configuration Update procedure.

| | |
|---|---|
| NOTE 4: | The AMF, for the case of UE not performing any actions despite the validity |

timing information provided by the network, can terminate PDU Session(s) associated with S-
NSSAI subject to be terminated according to the validity time by explicitly releasing the PDU
Sessions associated with the S-NSSAI.”

As can be seen from the above, a slice may not be available at a certain time and so each of the UE and the Access and Mobility Management Function, AMF, will remove the slice from the allowed NSSAI or partially allowed NSSAI when it is determined that the slice in question i.e. the S-NSSAI, is not available at the current time.

Support for slicing is provided for heterogenous coverage/deployment. Network slicing can be supported such that a slice may not be available in all the tracking areas (TAs) of a UE's registration area (RA), noting that an RA can contain a list of TAs identified by TA Identities (TAIs). The description of this can be found in section 5.15.18 of 3GPP TS 23.501, from which the following excerpt is provided:

“5.15.17 Partial Network Slice support in a Registration Area
A Network Slice may be supported in one or more TAs in a PLMN/stand-alone Non-Public
Network (SNPN). The Partial Network Slice support in a Registration Area for a UE includes
configuring the UE with a Partially Allowed NSSAI and/or S-NSSAI(s) rejected partially in the
RA.
When creating a Registration Area for UEs registering over the 3GPP access and supporting
the Partial Network Slice support in a Registration Area, the AMF may consider the trade-off
between signalling for paging in TAs where the S-NSSAI is not supported versus the signalling
for Mobility Registration Updates to register with the S-NSSAI in the TA(s) where the S-NSSAI
is supported, so that the AMF may create a Registration Area including the TA(s) where a
requested S-NSSAI is not supported. For supporting UEs, whether the AMF uses the Partially
Allowed NSSAI or rejects the S-NSSAIs partially in the RA, or whether the AMF rejects the S-
NSSAI for the current RA, is a per S-NSSAI decision which is based on AMF local policy. If
supported and allowed by local policy, the Partially Allowed NSSAI and S-NSSAIs rejected
partially in the RA may be applied simultaneously for one UE for different S-NSSAIs.
For such S-NSSAI:

| | |
|---|---|
| - | If requested by the UE from a TA where the S-NSSAI is not supported, |
| - | the S-NSSAI is included either in the Partially Allowed NSSAI or the AMF rejects the |

S-NSSAI partially in the RA; or

| | |
|---|---|
| - | if the S-NSSAI is subject to NSAC for maximum number of UEs, then the AMF should |

send this S-NSSAI as rejected partially in the RA, in the Registration Accept message.

| | |
|---|---|
| - | If the S-NSSAI is subject to NSSAA and successful NSSAA status for the S-NSSAI is not |

present in the AMF, then the AMF either sends this S-NSSAI as rejected partially in the RA in
the Registration Accept message, or the AMF starts executing NSSAA and includes the S-NSSAI
in the Pending NSSAI in the Registration Accept message. If the S-NSSAI is subject to NSSAA
and successful NSSAA status for the S-NSSAI is present, then the AMF may include the S-NSSAI
either in the Partially Allowed NSSAI or the AMF rejects the S-NSSAI partially in the RA.

| | |
|---|---|
| NOTE 1: | In roaming case the NSSAA requirement is based on the mapped S-NSSAI of |

the HPLMN.

| | |
|---|---|
| - | if the slice deregistration inactivity timer is configured for the S-NSSAI (see clause |

5.15.15.3), then AMF should send this S-NSSAI as rejected partially in the RA.

| | |
|---|---|
| - | If requested by the UE from a TA where the S-NSSAI is supported, |
| - | the S-NSSAI is included in the Partially Allowed NSSAI; or |
| - | if the S-NSSAI is subjected to NSAC for maximum number of UEs, then the AMF should |

restrict the RA so that the S-NSSAI is supported in all the TAs of the RA and includes the S-
NSSAI in the Allowed NSSAI.

| | |
|---|---|
| - | If the S-NSSAI is subject to NSSAA, then the AMF starts executing NSSAA and sends |

this S-NSSAI in the Pending NSSAI in the Registration Accept message, unless successful NSSAA
status is present in the AMF for this S-NSSAI (in which case it can be sent in the Partially
Allowed NSSAI).

| | |
|---|---|
| NOTE 2: | In roaming case the NSSAA requirement is based on the mapped S-NSSAI of |

the HPLMN.

| | |
|---|---|
| - | if the S-NSSAI is included in neither the Partially Allowed NSSAI nor the Allowed |

NSSAI, the AMF may reject the S-NSSAI as described in clause 5.15.4.1.1.
While the S-NSSAIs of the Allowed NSSAI are supported in all the TAs of the Registration Area,
the S-NSSAIs of the Partially Allowed NSSAI are supported only in the TAs corresponding to the
list of TAs (which are subset of the list of TAIs forming the Registration Area) associated with
the S-NSSAI.
If the UE supports Partial Network Slice support in a Registration Area, the AMF may create a
Registration Area for the UE considering the support of the S-NSSAIs of the Requested NSSAI
in the current TA and in the neighbouring TAs and provides to the UE in the Registration Accept
message or in the UE Configuration Update Command message the Partially Allowed NSSAI or
the S-NSSAIs rejected partially in the RA as follows:

| | |
|---|---|
| - | If one or more of the requested S-NSSAI(s) are supported in a subset of the TAs of the |

(potential) Registration Area, the AMF may include such S-NSSAI(s) in the Partially Allowed
NSSAI and corresponding mapping information of the S-NSSAI(s) of the Partially Allowed
NSSAI to the HPLMN S-NSSAI(s). For each S-NSSAI of the Partially Allowed NSSAI the AMF
provides a list of TAs where the S-NSSAI is supported. The UE is considered registered with the
S-NSSAI in the whole Registration area. The AMF also provides the Partially Allowed NSSAI
(without indication of the TA list where the partially allowed S-NSSAIs are supported) to the
NG-RAN together with the UE's context.

| | |
|---|---|
| - | Alternatively, the AMF may reject the S-NSSAI(s) with reject cause indicating ″partially |

in the RA″. For each S-NSSAI of the S-NSSAIs rejected partially in the RA the AMF provides a
list of TAs for which the S-NSSAI is supported or not supported.

| | |
|---|---|
| NOTE 3: | If the UE requests an S-NSSAI in a cell of a TA where the NS-AoS of the S- |

NSSAI does not match deployed Tracking Areas (see clause 5.15.18), the AMF includes the S-
NSSAI in the Allowed NSSAI or Partially Allowed NSSAI.
When the UE stores Partially Allowed NSSAI the following applies:

| | |
|---|---|
| - | the UE is considered registered with an S-NSSAI of the Partially Allowed NSSAI in the |

whole Registration area. The UE does not trigger registration when moving between the TAs of
support and non-support for the S-NSSAI within the RA.

| | |
|---|---|
| - | The UE is allowed to initiate PDU Session establishment for the S-NSSAI only when the |

UE is in a TA where the S-NSSAI is supported.

| | |
|---|---|
| - | If the AMF determines a PDU Session is associated with S-NSSAI present in the |

Partially Allowed NSSAI, the AMF indicates to the SMF that the PDU Session is subject to area
restrictions for the S-NSSAI. As a result, the SMF subscribes to ″UE mobility event notification″
for reporting UE presence in Area of Interest by providing S-NSSAI to the AMF as described in
clauses 5.6.11 and 5.3.4.4.

| | |
|---|---|
| - | When the UE has already established a PDU Session with an S-NSSAI part of the |

Partially Allowed NSSAI, the UE is allowed to activate the User Plane Resources of the PDU
Session only when the UE is in a TA part of the list of TAs associated with each S-NSSAI.

| | |
|---|---|
| - | When the User Plane Resources are activated for a PDU Session of an S-NSSAI part of |

the Partially Allowed NSSAI and the UE moves to a TA which is not part of the list of TAs
associated with the S-NSSAI, the User Plane Resources for the PDU Session shall be
deactivated, but the PDU Session context in UE and SMF is not released. The User Plane
Resources for the PDU Session shall not be activated as long as the UE is located in a TA which
is not part of the list of TAs associated with the S-NSSAI of the Partially Allowed NSSAI. The
UE shall not send user data as payload of a NAS message (see clause 5.31.4.1) in uplink
directions. When the SMF is notified by the AMF that the UE location is outside of the Area of
Interest, the SMF shall not send user data as payload of NAS message (see clause 5.31.4.1) in
downlink directions and disable data notification.

| | |
|---|---|
| Editor's note: | Whether and based on what criteria to trigger the reporting and the handling |

of the transition to CM-IDLE for UEs with PDU Sessions and the applicability to the CP CIOT
optimization use cases are FFS.
When the UE stores a S-NSSAI rejected partially in the RA with the associated list of TAs, the
UE is allowed to initiate a Mobility Registration Update procedure to request registration with
the S-NSSAI only when the UE is in a TA supporting this S-NSSAI.
For a UE in CM-CONNECTED state, when a PDU Session is established on an S-NSSAI
included in the Partially Allowed NSSAI, the User Plane resources are activated and the UE
moves to a TA where the S-NSSAI is not supported, the NG-RAN deactivates the User Plane
resources as described in the AN initiated modification of a PDU Session in clause 4.3.3.2 of TS
23.502 [3].
5.15.18.1 General
The network support for a Network Slice is defined on a per Tracking Area granularity. It may
be beneficial to deploy some Network Slices such that the Network Slice have a limited
geographical availability that is not matching existing Tracking Area boundaries.
The operator can in this case decide to change the topology of the Tracking Areas so they match
the boundaries of the Network Slice, or the operator may configure resources for the Network
Slices in the cells of TAs where the Network Slices are to be available, and in areas of the TAs
where the network slice is defined to be not available the cells are configured with zero
resources.
The AMF receives from the OAM the information on availability of a network slice when the
granularity is smaller than TA, i.e. if the NS-AoS includes TAs where the network slice is not
available in some cells of the TA.
In order to optimize the end-to-end behaviour, the AMF can, based on NS-AoS information
received from OAM, configure supporting UEs with S-NSSAI location availability information,
and the network may need to monitor the S-NSSAI usage and enforce the NS-AoS e.g. if the UE
does not support the S-NSSAI location availability information.
5.15.18.2 S-NSSAI location availability information
S-NSSAI location availability information defines additional restrictions to the usage of an S-
NSSAI in TAs where the Network Slice availability does not match the TA boundaries. The AMF
is configured per S-NSSAI whether to send the S-NSSAI location availability information to
supporting UEs.
The S-NSSAI location availability information sent to the UE includes, for each applicable S-
NSSAI of the Configured NSSAI, Location information indicating the cells of TAs in the RA
where the related S-NSSAI is available if the S-NSSAI is not available in all the cells of the TA.
If the UE has indicated that the UE supports S-NSSAI location availability information in the
5GMM Core Network Capability (see clause 5.4.4a), the AMF may, based on OAM
configuration, configure the UE with S-NSSAI location availability information for one or more
S-NSSAIs when the AMF allocates an RA where the Network Slice availability does not match
whole TAs, by including the S-NSSAI location availability information in the Registration Accept
message or the UE Configuration Command message. A UE that receives S-NSSAI location
availability information applies the information as follows.

| | |
|---|---|
| 1. | If the S-NSSAI is rejected in the RA or rejected partially in the RA or rejected with a |

cause code that allows attempting to register the S-NSSAI again, the UE can request the S-NSSAI
only if the S-NSSAI location availability information indicates that the S-NSSAI is available at
the cell where the UE is camping.

| | |
|---|---|
| 2. | If the S-NSSAI is in the Partially Allowed NSSAI or in the Allowed NSSAI, the UE shall |

not activate User Plane for any already established PDU Session with that S-NSSAI if the UE is
in a cell within the RA but outside the Location information of the S-NSSAI. The UE and SMF
shall not exchange user data as payload of a NAS message in both uplink and downlink
directions.

| | |
|---|---|
| 3. | If the S-NSSAI is in the Partially Allowed NSSAI or in the Allowed NSSAI, and the UE |

in CM-IDLE mode is moved to a cell outside the Location information of the S-NSSAI, and the
UE has an established PDU Session with that S-NSSAI, the PDU Session is kept.

| | |
|---|---|
| NOTE 1: | By Radio Resource Management and existing mechanisms in NG-RAN, |

handover can be used to keep the UE in the NS-AoS or steer the UE to enter the NS-AoS as long
as radio conditions allow it.

| | |
|---|---|
| NOTE 2: | Since the S-NSSAI location availability information is not a used as a trigger |

for the UE to perform MRU due to mobility, i.e. the UE performs MRU due to mobility upon
changing to a new TA outside the UE's Registration Area, the S-NSSAI remains registered and
is included in the Allowed NSSAI when the UE exits the NS-AoS. If the S-NSSAI is subject for
NSAC, the S-NSSAI is counted towards NSAC as described in clause 5.15.11 also when the UE
is outside the NS-AoS.
5.15.18.3 Network based monitoring and enforcement of Network Slice Area of Service not
matching deployed Tracking Areas
OAM may configure RRM policies for S-NSSAIs on a per cell basis as defined in TS 28.541
[149], i.e. cells outside the Network Slice Area of Service while in a TA supporting the S-NSSAI
are allocated with no RRM resources for the S-NSSAI.
The network may enforce the NS-AoS for an S-NSSAI as follows:

| | |
|---|---|
| 1. | The network may monitor the validity of the S-NSSAI for UE in CM-CONNECTED |

state, i.e. the AMF subscribes to the AoI using the Location information of the S-NSSAI location
availability information as described in TS 38.413 [34].

| | |
|---|---|
| 2. | If the non-supporting UE makes a PDU Session establishment request with an S-NSSAI |

that is not valid as per the S-NSSAI location availability information, the AMF may reject the
NAS Transport message with a back-off timer using S-NSSAI based congestion control as
described in clause 5.19.7.4.

| | |
|---|---|
| 3. | If the AMF determines that the UE in CM-CONNECTED has moved outside the NS- |

AoS, the AMF performs the following logic:

| | |
|---|---|
| a) | If the non-supporting UE has other S-NSSAI(s) in the Allowed NSSAI, then the AMF |

may update the UE with a UE Configuration Update by removing the S-NSSAI from the Allowed
NSSAI (which causes the UE to locally release the PDU Sessions) and optionally removing the
S-NSSAI from the Configured NSSAI and then, the AMF requests the SMF to locally release in
the network any PDU Sessions with that S-NSSAI as per step 1f in clause 4.2.3.4 in TS 23.502
[3]. Alternatively, the AMF requests the SMF to release PDU Sessions with that S-NSSAI.

| | |
|---|---|
| b) | If the non-supporting UE does not have any other S-NSSAI in the Allowed NSSAI, then |

the AMF may update the UE with a UE Configuration Update by removing the S-NSSAI from
the Allowed NSSAI (which causes the UE to locally release the PDU Sessions) and optionally
removing the S-NSSAI from the Configured NSSAI, and adding a default S-NSSAI to the Allowed
NSSAI and then, the AMF requests the SMF to locally release in the network any PDU Sessions
with the removed S-NSSAI as per step If in clause 4.2.3.4 in TS 23.502 [3]. Alternatively, the
AMF requests the SMF to release PDU Sessions with that S-NSSAI.

| | |
|---|---|
| NOTE: | Whether the AMF removes the S-NSSAI from Allowed NSSAI and Configured NSSAI or |

only releases the associated PDU Sessions when the AMF enforces the NS-AoS is up to AMF
configuration.

| | |
|---|---|
| c) | For a non-supporting UE that does not have any other S-NSSAI in the Allowed NSSAI |

nor in the Configured NSSAI, then the AMF indicates to the SMF to release the PDU Session.

| | |
|---|---|
| 4. | If the AMF determines that the S-NSSAI becomes valid e.g. the UE has moved into the |

NS-AoS, the AMF may update the UE with a UCU e.g. including the S-NSSAI in the Configured
NSSAI.”

From the above, it can be seen that when the slices are not available in all TAs of the RA, the slice which is available is included in the partially allowed NSSAI and hence can be used by the UE in that TA. The UE may be provided with location information regarding the applicability of a slice (or an S-NSSAI) in a cell of a TA. Per the requirements from 3GPP TS 23.501 V18.2.1, the UE is only allowed to use a slice if the cell supports the slice in question. In particular, if the slice (or S-NSSAI) is in the Partially Allowed NSSAI or in the Allowed NSSAI, the UE shall not activate User Plane, UP, for any already established PDU Session with that S-NSSAI if the UE is in a cell within the RA but outside the location information of the S-NSSAI.

In connection with slice selection during PDU session establishment, with the exception of emergency services, the UE would normally attempt to indicate a slice for which a request to establish a PDU session is to be made. The UE may have URSP (UE Route Selection Policies) rules based on which an S-NSSAI is determined when e.g. a new application is used.

Once determined, the UE will request the establishment of a PDU session and indicate the S-NSSAI which has been determined. The details of the URSP rules can be found in 3GPP TS 24.526 V18.4.0.

Based on verifications against the URSP rules, it is possible that no S-NSSAI can be determined for the application in question and hence for the PDU session that may be requested. In this case, the UE may send the request for a PDU session without any explicit S-NSSAI. In this case, the AMF will select an S-NSSAI for the PDU session that is to be established and the method to do so is provided below from 3GPP TS 24.501 V18.3.0:

“Upon reception of a UL NAS TRANSPORT message, if the Payload container type IE is set to:

| a) | ″NI SM information″, the AMF looks up a PDU session routing context for: |
|---|---|
| 1) | the UE and the PDU session ID IE in case the Old PDU session ID IE is not included, |

and:
NOTE 1: If the Old PDU session ID IE is not included in the UL NAS TRANSPORT
message and the AMF has received a reallocation requested indication from the SMF, the AMF
needs to ignore the reallocation requested indication.

| | |
|---|---|
| i) | if the AMF has a PDU session routing context for the PDU session ID and the UE, and |

the Request type IE is either not included or is included but set to other value than ″initial
request″, ″existing PDU session″, ″initial emergency request″, ″existing emergency PDU
session″ or ″MA PDU request″, the AMF shall send the 5GSM message, and the PDU session
ID IE towards the SMF identified by the SMF ID of the PDU session routing context;

| | |
|---|---|
| ii) | if the AMF has a PDU session routing context for the PDU session ID and the UE, the |

PDU session routing context indicates that the PDU session is not an emergency PDU session,
the Request type IE is included and is set to ″existing PDU session″ or ″MA PDU request″, and
the S-NSSAI associated with the PDU session identified by the PDU session ID is allowed for
the target access type, the AMF shall send the 5GSM message, the PDU session ID, the S-NSSAI,
the mapped S-NSSAI (in roaming scenarios), the DNN (if received) and the request type towards
the SMF identified by the SMF ID of the PDU session routing context;

| | |
|---|---|
| iii) | if the AMF does not have a PDU session routing context for the PDU session ID and |

the UE, and the Request type IE is included and is set to ″initial request″ or ″MA PDU request″:

| | |
|---|---|
| A) | the AMF shall select an SMF with following handlings in case the UE is not registered |

for onboarding services in SNPN:

| | |
|---|---|
| | If the S-NSSAI IE is not included and the allowed NSSAI contains: |
| - | one S-NSSAI, the AMF shall use the S-NSSAI in the allowed NSSAI as the S-NSSAI; |
| - | two or more S-NSSAIs and the user's subscription context obtained from UDM contains |

only one default S-NSSAI that is included in the allowed NSSAI, the AMF shall use the S-NSSAI
in the allowed NSSAI that matches the default S-NSSAI as the S-NSSAI; or

| | |
|---|---|
| - | two or more S-NSSAIs and the user's subscription context obtained from UDM contains |

two or more default S-NSSAI(s) included in the allowed NSSAI, the AMF shall use an S-NSSAI
in the allowed NSSAI selected based on operator policy as the S-NSSAI.

If the S-NSSAI or the mapped S-NSSAI (in roaming scenarios) is an S-NSSAI to be

replaced and the alternative S-NSSAI is not provided by the UE, the AMF shall retrieve an
alternative S-NSSAI (see clause 5.15.19 of 3GPP TS 23.501).

As can be seen above, the AMF will select an S-NSSAI from the allowed NSSAI only.

A problem is experienced in the prior art if or when the UE does not explicitly indicate (or provide or request) an S-NSSAI as part of the PDU session establishment procedure.

When this happens, the AMF is expected to select an S-NSSAI for the PDU session which is being requested. The selection process has been set out above from and there it is noted that the AMF only considers the allowed NSSAI when making this selection i.e. the partially allowed NSSAI is not considered. This then leads to the following problems:
The UE may have a partially allowed NSSAI and, moreover, the UE may actually be in the TA where one or more slices in the partially allowed NSSAI is supported. The prior art AMF behaviour for S-NSSAI selection completely ignores the partially allowed NSSAI. In fact the entry (or entries) in the partially allowed NSSAI may be more suitable for the UE in question and so the AMF (by considering only the allowed NSSAI) can then end up selecting a slice which provides a non-optimal PDU session for the UE
The UE may be in a cell which does not support a particular S-NSSAI-where this may be a case for which the UE is provided with Network Slice Area of Service (NS-AoS) information. According to the prior art selection mechanism, the AMF does not verify if the cell upon which the UE is camped actually supports the S-NSSAI(s) in the allowed NSSA or in the partially allowed NSSAI. Therefore, the AMF may end up selecting a slice which is actually not supported in the cell and this will lead to negative impacts, as the service will not be available and the UE's request will be delayed. In fact, the UE may re-send its request which may then continuously fail. It is not clear how the system will react to such a failure and how much time will be needed to resolve it. This kind of behaviour is undesirable.
The prior art slice selection mechanism does not consider the slice's time of availability. It is possible that the UE may send a request for a PDU session (without any S-NSSAI) such that one or more slices in the UE's allowed NSSAI (or partially allowed NSSAI) is not available at the current time. However, the AMF behaviour does not verify the availability of a slice based on time. As such the AMF may end up selecting a slice which is not available.

The above shows that the existing AMF behaviour for selecting an S-NSSAI, when the UE does not provide one during a PDU session establishment procedure, is not optimal and in fact may not work at all in some cases. As such, a different AMF consideration is needed when slice selection is performed.

Embodiments of the present invention aim to address these issues and to provide additional AMF behaviours where necessary.

According to the present invention there is provided an apparatus and method as set forth in the appended claims. Other features of the invention will be apparent from the dependent claims, and the description which follows.

According to a first aspect of the present invention, there is provided a method of a User Equipment, UE, establishing a Protocol Data Unit, PDU, session with a network, where the UE has been provided with Network Slice Area of Service, NS-AoS, but does not provide a requested Single Network Slice Selection Assistance Information, S-NSSAI, wherein the network verifies if an S-NSSAI in an allowed Network Slice Selection Assistance Information, NSSAI, is inside the NS-AoS and, if so, then the S-NSSAI in the allowed NSSAI is identified as a selected S-NSSAI.

In an embodiment, the UE does not have a partially allowed NSSAI. and has an allowed NSSAI

According to a second aspect of the present invention, there is provided a method of a User Equipment, UE, establishing a Protocol Data Unit, PDU, session with a network where the UE does not provide a requested Single Network Slice Selection Assistance Information, S-NSSAI, wherein the UE has both an allowed NSSAI and a partially allowed NSSAI, wherein:

if the network is configured to, or determines to, use the allowed NSSAI then for a UE which has been provided a NS-AoS, the network verifies if an S-NSSAI in an allowed Network Slice Selection Assistance Information, NSSAI, is inside the NS-AoS and, if so, then the S-NSSAI in the allowed NSSAI is identified as a selected S-NSSAI; or

if the network is configured to, or determines to, use the partially allowed NSSAI, then the network verifies if an S-NSSAI is supported in a current Tracking Area Identity, TAI, of the UE and if so, then the network uses the S-NSSAI as a selected S-NSSAI.

In an embodiment, the UE sends a UL NAS TRANSPORT message with a Payload container type Information Element, IE, set to “N1 SM information” and the Request type IE is included and is set to “initial request”.

In an embodiment, allowed NSSAI indicates S-NSSAI values the UE could use in the Serving Public Land Mobile Network, PLMN, in a current Registration Area, RA.

In an embodiment, Partially Allowed NSSAI indicates S-NSSAI values the UE could use in the Serving PLMN or stand-alone Non-Public Network, SNPN, in some of the Tracking Areas, Tas, in a current Registration Area, RA.

In an embodiment, each S-NSSAI in the Partially Allowed NSSAI is associated with a list of TAs where the S-NSSAI is supported.

In an embodiment, Network Slice Area of Service (NS-AoS) relates to an area where a network slice is available, such that the UE can access and get service of a particular network slice as more than zero resources are allocated to the network slice.

In an embodiment, the area may be one of, depending on the specific network slice: the whole PLMN, one or more TAs, or one or more cells when the NS-AoS does not match deployed Tas.

According to a third aspect of the present invention, there is provided apparatus arranged to perform the method of any preceding aspect.

Embodiment of the present invention apply (at least) for the case when the AMF receives a 5GSM request from the UE where the request is to establish a new PDU session and where the UE did not provide an S-NSSAI for the request. The AMF is thereby expected to perform S-NSSAI selection:
As part of the S-NSSAI selection, if the UE in question has a partially allowed NSSAI, then the AMF should consider the entries of the partially allowed NSSAI for selection of a slice. This may be done in addition to the entries of the allowed NSSAI
The AMF should verify if the slice is supported in the area of the UE, where this may be at a TA level (in the case of the partially allowed NSSAI) or at the cell level in the case for which the UE has NS-AoS
If the AMF chooses a slice from the allowed NSSAI, then the AMF should ensure that the slice is available based on the validity time which is associated with the slice.
Alternatively the AMF should ensure that the default slice is always available only in the allowed NSSAI

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

FIG. 1 shows a schematic representation of an embodiment of the invention.

In an embodiment, the network ensures that the all default S-NSSAIs are only present in the allowed NSSAI.

This embodiment provides that the network (e.g. the AMF) should ensure that the default S-NSSAI is only available in, or is included only in, the allowed NSSAI. By doing so, the network ensures that the allowed NSSAI will always contain at least one default S-NSSAI which can be selected by the AMF when the UE does not indicate an S-NSSAI during (or as part of) the PDU session establishment procedure. Therefore, when sending the allowed NSSAI and optionally a partially allowed NSSAI to the UE, the AMF should ensure that any default S-NSSAI is only included in the allowed NSSAI and that no default S-NSSAI is included in the partially allowed NSSAI.

Furthermore, the AMF may only use the allowed NSSAI for selecting an S-NSSAI when the UE does not provide any S-NSSAI even if the UE has a partially allowed NSSAI.

Alternatively, or additionally, the network (e.g. AMF) should ensure that there is at least one S-NSSAI (optionally which is a default S-NSSAI) in the allowed NSSAI such that:
The S-NSSAI is available in all the tracking areas, or at least in one tracking area.
The S-NSSAI is not supported only on a cell level.
The S-NSSAI is not available on a temporary basis i.e. the S-NSSAI is available always

In another embodiment, the network should also consider the partially allowed NSSAI when selecting a slice during PDU session establishment (for which the UE does not indicate an S-NSSAI).

This embodiment provides that the network (e.g. the AMF) should also consider the partially allowed NSSAI for selecting a slice (or an S-NSSAI) when the UE does not explicitly indicate an S-NSSAI during the PDU session establishment procedure.

The network (e.g. AMF) may be configured to operate in any of the following ways when the selection of a slice (or S-NSSAI) is needed as part of the PDU session establishment procedure for which the UE does not indicate any S-NSSAI:
The network (e.g. AMF) only considers the allowed NSSAI even if the UE has a partially allowed NSSAI
The network (e.g. AMF) only considers the partially allowed NSSAI (although the UE may have an allowed NSSAI)
The network (e.g. AMF) considers both the allowed NSSAI and the partially allowed NSSAI.

Note that the steps set out above (regarding consideration of either the allowed NSSAI, or the partially allowed NSSAI, or both) means that the network (e.g. AMF) would use the indicated list for S-NSSAI selection, optionally when the UE does not indicate an S-NSSAI during PDU session establishment procedure.

In this embodiment, the network (e.g. AMF) operates such that both the allowed NSSAI and the partially allowed NSSAI are considered, optionally when the network (e.g. AMF) is configured to do so.

The following may apply for the case when the UE has both an allowed NSSAI and a partially allowed NSSAI but the UE does not explicitly indicate an S-NSSAI during a PDU session establishment procedure:
The AMF may prioritize selecting a slice from the allowed NSSAI
   Alternatively, the AMF may prioritize selecting a slice from the partially allowed NSSAI and then use the allowed NSSAI if the AMF is not able to select form the partially allowed NSSAI for any reason
If the AMF determines that a slice from the allowed NSSAI cannot be selected, then the AMF should select a slice from the partially allowed NSSAI
   the AMF may determine that it cannot use any slice from the allowed NSSAI for any of the following reasons or when any of the following occur:
      The DNN which is either requested by the UE or selected by the network (e.g. by the AMF) is not supported over (or via) any slice from the allowed NSSAI
      The UE is provided with Network Slice Area of Service such that there is at least one slice, or all the slices, in the allowed NSSAI which is (are) not supported in the UE's current location where the location may be cell where the UE is camped on
When selecting a slice from the partially allowed NSSAI, the AMF should ensure any of the following:
   that any slice which is selected (or to be selected) is (or will be) supported in the TA where the UE is currently located in
      Note that the AMF can be aware of the UE's current TA based on information it receives from the NG-RAN, and it should then verify if the slice in the partially allowed NSSAI is supported in the TA where the UE is located
   if a slice is subject to being temporarily available (or hence temporarily not available at some times), optionally for a UE which has been provided with a validity time, then the AMF should only select the slice if the slice is available at the current time. As such, for any slice which is subject to validity time (i.e. which may not be available at all times), the AMF should only select the slice if the slice is available. As such, if the slice is currently not available, then the AMF should not select the slice
If the AMF is not able to select any slice based on the above, then the AMF should select any slice which is deemed to be a default slice.

Note that other forms of prioritization can also be used. The above are examples of how the different lists can be prioritized for selecting a slice (when the UE does not explicitly indicate or request an S-NSSAI during PDU session establishment procedure), however one key concept is that when the UE does not indicate an S-NSSAI during PDU session establishment, then the AMF needs to take any of the following actions in any order or combination:
If the UE has both an allowed NSSAI and a partially allowed NSSAI, then the AMF needs to consider both lists for selecting a slice, although different prioritization mechanisms may be used for prioritizing one list over the other. The above is one example of such prioritization
If the AMF selects a slice from the partially allowed NSSAI, the AMF has to ensure that the (potentially) selected slice is supported in the TA where the UE is present. Alternatively, the AMF considers a slice for selection only if the slice is supported in the TA where the UE is present and, as such, the AMF does not select any slice if the slice is not supported in the TA where the UE is present
If the AMF selects a slice from the allowed NSSAI and the UE was provided with a NS-AoS, then the AMF should select a slice only if the slice is supported in the cell where the UE is present
If the AMF selects a slice from the allowed NSSAI and the UE was provided with a validity time for slices, then the AMF should select a slice only if the slice is currently available (or is available at the current time based on the validity time information that was provided to the UE)
If the AMF is not able to select a slice based on the above, the AMF may select a default slice regardless of where the default slice is available i.e. regardless of where the default slice is available in the allowed NSSAI or the partially allowed NSSAI.

For all of the embodiments described herein, the establishment of a PDU session or the procedure for establishing a PDU session can refer to the UE sending an UL NAS TRANSPORT message with the Payload container type IE indicating that the content of the Payload container IE is a 5GSM message (e.g. the Payload container type IE indicates “N1 SM information”), and the Request type IE indicates “initial request”.

For all the embodiments described herein, the term slice may refer to at least one S-NSSAI.

FIG. 1 shows, for completeness, a schematic of an embodiment of the invention.

FIG. 1 represents a method of a User Equipment, UE, establishing a Protocol Data Unit, PDU, session with a network. At S101, the UE has been provided with Network Slice Area of Service, NS-AoS, but does not provide a requested Single Network Slice Selection Assistance Information, S-NSSAI. At S102, the network verifies if an S-NSSAI in an allowed Network Slice Selection Assistance Information, NSSAI, is inside the NS-AoS and, if so, then at S103 the S-NSSAI in the allowed NSSAI is identified as a selected S-NSSAI.

FIG. 2 illustrates an example of an internal structure of an apparatus according to an embodiment of the disclosure.

Referring to FIG. 2, the apparatus 200 of the disclosure may comprises a UE or an AMF according to an embodiment of the disclosure. The apparatus 200 may include at least one of a transceiver 230, a memory 220, or a processor 210. The processor 210, transceiver 230, and memory 220 of the apparatus may be operated according to the above-described UE method or AMF method. However, the components of the apparatus are not limited thereto. For example, the apparatus may include more or fewer components than the above-described components. The processor 210, the transceiver 230, and the memory 220 may be implemented in the form of a single chip.

The transceiver 230 collectively refers to the transmitter of the apparatus and the receiver of the apparatus and may transmit and receive signals to/from the other network entity (e.g., a UE or an AMF). The signals transmitted/received with the apparatus may include control information and data. To that end, the transceiver 230 may include a radio frequency (RF) transmitter for frequency-up converting and amplifying signals transmitted and an RF receiver for low-noise amplifying signals received and frequency-down converting the frequency of the received signals. However, this is merely an example of the transceiver 230, and the components of the transceiver 230 are not limited to the RF transmitter and the RF receiver.

Further, the transceiver 230 may include a wired/wireless transceiver and may include various components for transmitting/receiving signals.

The transceiver 230 may receive signals via a radio channel, output the signals to the processor 210, and transmit signals output from the processor 210 via a radio channel.

Further, the transceiver 230 may receive communication signal and output it to the processor 210 and transmit the signal output from the processor 210 to the network entity through the wired/wireless network.

The memory 220 may store programs and data necessary for the operation of the apparatus. The memory 220 may store control information or data that is included in the signal obtained by the apparatus. The memory 220 may include a storage medium, such as read-only memory (ROM), random access memory (RAM), hard disk, compact disc read only memory (CD-ROM), and digital versatile disc (DVD), or a combination of storage media.

The processor 210 may control a series of processes for the apparatus to be able to operate according to the above-described embodiments. The processor 210 may include at least one processor. For example, the processor 210 may include a communication processor (CP) that performs control for communication and an application processor (AP) that controls an upper layer, such as an application program.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Although the present disclosure has been described with various embodiments, various changes and modifications may be suggested to one skilled in the art. It is intended that the present disclosure encompass such changes and modifications as fall within the scope of the appended claims.

Disclosed is a method of a User Equipment, UE, establishing a Protocol Data Unit, PDU, session with a network, where the UE has been provided with Network Slice Area of Service, NS-AoS, but does not provide a requested Single Network Slice Selection Assistance Information, S-NSSAI, wherein the network verifies if an S-NSSAI in an allowed Network Slice Selection Assistance Information, NSSAI, is inside the NS-AoS and, if so, then the S-NSSAI in the allowed NSSAI is identified as a selected S-NSSAI.

According to an aspect of the present disclosure, there is provided a method performed by an access and mobility management function (AMF) in wireless communication system, the method comprising: receiving, from a user equipment (UE), an uplink non-access stratum (UL NAS) transport message including a payload container type information element (IE) set to N1 SM information and a request type IE indicating initial request;

According to an aspect of the present disclosure, there is provided a method performed by an access and mobility management function (AMF) in wireless communication system, the method comprising: identifying that a single network slice selection assistance information (S-NSSAI) IE is not included in the UL NAS transport message.

According to an aspect of the present disclosure, there is provided a method performed by an access and mobility management function (AMF) in wireless communication system, the method further comprising: in case that an allowed NSSAI provided to UE includes a first S-NSSAI, identifying the first S-NSSAI in the allowed NSSAI, wherein a network slice area of service (NS-AoS) is provided to the UE, and wherein the first S-NSSAI is related to the NS- AoS where the UE is present.

According to an aspect of the present disclosure, there is provided a method performed by an access and mobility management function (AMF) in wireless communication system, the method further comprising: in case that an allowed NSSAI and a partially allowed NSSAI are provided to the UE, selecting a second S-NSSAI from the allowed NSSAI, wherein a network slice area of service (NS-AoS) is provided to the UE, and wherein the second S-NSSAI is related to the NS-AoS where the UE is present.

According to an aspect of the present disclosure, there is provided a method performed by an access and mobility management function (AMF) in wireless communication system, the method further comprising: in case that an allowed NSSAI and a partially allowed NSSAI are provided to the UE, selecting a third S-NSSAI from the partially allowed NSSAI, wherein the third S-NSSAI is associated with tracking area (TA) where the UE is present.

According to an aspect of the present disclosure, there is provided a method performed by an access and mobility management function (AMF) in wireless communication system, the method further comprising: ensuring the third S-NSSAI is associated with the TA where the UE is present.

According to an aspect of the present disclosure, there is provided a method performed by a user equipment (UE) in wireless communication system, the method comprising: transmitting, to an access and mobility management function (AMF), an uplink non-access stratum (UL NAS) transport message including a payload container type information element (IE) set to N1 SM information and a request type IE indicating initial request, wherein a single network slice selection assistance information (S-NSSAI) IE is not included in the UL NAS transport message.

According to an aspect of the present disclosure, there is provided a method performed by a user equipment (UE) in wireless communication system, the method further comprising: wherein in case that an allowed NSSAI provided to UE includes a first S-NSSAI, the first S-NSSAI in the allowed NSSAI is identified, wherein a network slice area of service (NS- AoS) is provided to the UE, and wherein the first S-NSSAI is related to the NS-AoS where the UE is present.

According to an aspect of the present disclosure, there is provided a method performed by a user equipment (UE) in wireless communication system, wherein in case that an allowed NSSAI and a partially allowed NSSAI are provided to the UE, a second S-NSSAI from the allowed NSSAI is selected, wherein a network slice area of service (NS-AoS) is provided to the UE, and wherein the second S-NSSAI is related to the NS-AoS where the UE is present.

According to an aspect of the present disclosure, there is provided a method performed by a user equipment (UE) in wireless communication system, wherein in case that an allowed NSSAI and a partially allowed NSSAI are provided to the UE, a third S-NSSAI from the partially allowed NSSAI is selected, and wherein the third S-NSSAI is associated with tracking area (TA) where the UE is present.

According to an aspect of the present disclosure, there is provided a method performed by a user equipment (UE) in wireless communication system, wherein the NS-AoS relates to an area where a network slice is available, wherein the third S-NSSAI is associated with the TA is ensured.

What is claimed is:

1. A method performed by an access and mobility management function (AMF) in wireless communication system, the method comprising:
receiving, from a user equipment (UE), an uplink non-access stratum (UL NAS) transport message including a payload container type information element (IE) set to N1 SM information and a request type IE indicating initial request; and
identifying that a single network slice selection assistance information (S-NSSAI) IE is not included in the UL NAS transport message.

2. The method of claim 1, further comprising:
in case that an allowed NSSAI provided to UE includes a first S-NSSAI, identifying the first S-NSSAI in the allowed NSSAI,
wherein a network slice area of service (NS-AoS) is provided to the UE, and
wherein the first S-NSSAI is related to the NS-AoS where the UE is present.

3. The method of claim 1, further comprising:
in case that an allowed NSSAI and a partially allowed NSSAI are provided to the UE, selecting a second S-NSSAI from the allowed NSSAI,
wherein a network slice area of service (NS-AoS) is provided to the UE, and
wherein the second S-NSSAI is related to the NS-AoS where the UE is present.

4. The method of claim 1, further comprising:
in case that an allowed NSSAI and a partially allowed NSSAI are provided to the UE, selecting a third S-NSSAI from the partially allowed NSSAI, wherein the third S-NSSAI is associated with tracking area (TA) where the UE is present.

5. The method of claim 4, further comprising:
ensuring the third S-NSSAI is associated with the TA where the UE is present.

6. A method performed by a user equipment (UE) in wireless communication system, the method comprising:
transmitting, to an access and mobility management function (AMF), an uplink non-access stratum (UL NAS) transport message including a payload container type information element (IE) set to N1 SM information and a request type IE indicating initial request, wherein a single network slice selection assistance information (S-NSSAI) IE is not included in the UL NAS transport message.

7. The method of claim 6, wherein in case that an allowed NSSAI provided to UE includes a first S-NSSAI, the first S-NSSAI in the allowed NSSAI is identified,
wherein a network slice area of service (NS-AoS) is provided to the UE, and
wherein the first S-NSSAI is related to the NS-AoS where the UE is present.

8. The method of claim 6, wherein in case that an allowed NSSAI and a partially allowed NSSAI are provided to the UE, a second S-NSSAI from the allowed NSSAI is selected,
wherein a network slice area of service (NS-AoS) is provided to the UE, and
wherein the second S-NSSAI is related to the NS-AoS where the UE is present.

9. The method of claim 8, wherein in case that an allowed NSSAI and a partially allowed NSSAI are provided to the UE, a third S-NSSAI from the partially allowed NSSAI is selected, and
wherein the third S-NSSAI is associated with tracking area (TA) where the UE is present.

10. The method of claim 9, wherein the third S-NSSAI is associated with the TA is ensured.

11. An access and mobility management function (AMF) in wireless communication system, comprising:
a transceiver; and
a processor configured to:
receive, from a user equipment (UE), an uplink non-access stratum (UL NAS) transport message including a payload container type information element (IE) set to N1 SM information and a request type IE indicating initial request, and
identify that a single network slice selection assistance information (S-NSSAI) IE is not included in the UL NAS transport message.

12. The AMF of claim 11, wherein the processor is further configured to:
in case that an allowed NSSAI provided to UE includes a first S-NSSAI, identifying the first S-NSSAI in the allowed NSSAI,
wherein a network slice area of service (NS-AoS) is provided to the UE, and
wherein the first S-NSSAI is related to the NS-AoS where the UE is present.

13. The AMF of claim 11, wherein the processor is further configured to:
in case that an allowed NSSAI and a partially allowed NSSAI are provided to the UE, selecting a second S-NSSAI from the allowed NSSAI,
wherein a network slice area of service (NS-AoS) is provided to the UE, and
wherein the second S-NSSAI is related to the NS-AoS where the UE is present.

14. The AMF of claim 11, wherein the processor is further configured to:
in case that an allowed NSSAI and a partially allowed NSSAI are provided to the UE, selecting a third S-NSSAI from the partially allowed NSSAI, wherein the third S-NSSAI is associated with tracking area (TA) where the UE is present.

15. The AMF of claim 14, wherein the processor is further configured to:
ensuring the third S-NSSAI is associated with the TA where the UE is present.

16. A user equipment (UE) in wireless communication system, comprising:
a transceiver; and
a processor configured to:
transmit, to an access and mobility management function (AMF), an uplink non-access stratum (UL NAS) transport message including a payload container type information element (IE) set to N1 SM information and a request type IE indicating initial request,
wherein a single network slice selection assistance information (S-NSSAI) IE is not included in the UL NAS transport message.

17. The UE of claim 16, wherein in case that an allowed NSSAI provided to UE includes a first S-NSSAI, the first S-NSSAI in the allowed NSSAI is identified,
wherein a network slice area of service (NS-AoS) is provided to the UE, and
wherein the first S-NSSAI is related to the NS-AoS where the UE is present.

18. The UE of claim 16, wherein in case that an allowed NSSAI and a partially allowed NSSAI are provided to the UE, a second S-NSSAI from the allowed NSSAI is selected,
wherein a network slice area of service (NS-AoS) is provided to the UE, and
wherein the second S-NSSAI is related to the NS-AoS where the UE is present.

19. The UE of claim 18, wherein in case that an allowed NSSAI and a partially allowed NSSAI are provided to the UE, a third S-NSSAI from the partially allowed NSSAI is selected, and
wherein the third S-NSSAI is associated with tracking area (TA) where the UE is present.

20. The UE of claim 19, wherein the third S-NSSAI is associated with the TA is ensured.
